(19) United States
(12) Patent Application Publication
(10) Pub. No.: US 2015/0324856 A1
(43) Pub. Date: Nov. 12, 2015

(54) ADVERTISEMENT UNIT AND A METHOD THEREOF

(71) Applicant: 2 TRACK LTD., Tel- Aviv (IL)

(72) Inventor: Nir Shay, Modiin (IL)

(21) Appl. No.: 14/655,339

(22) PCT Filed: Dec. 15, 2013
(86) PCT No.: PCT/IL2013/051036

§ 371 Date: Jun. 25, 2015

Related U.S. Application Data
(60) Provisional application No. 61/745,966, filed on Dec. 26, 2012.

(51) Int. Cl. G06Q 30/02; G06F 3/01; G06F 3/0485

(52) U.S. Cl. CPC G06Q 30/0267; G06F 3/0485; G06F 3/013

(57) ABSTRACT

A method is disclosed for displaying two series of content items simultaneously on a certain screen area. The method includes receiving user signals regarding user attention to the already displayed items of a first series of text items, extracting an indication that the user attention is focused outside a certain zone, and displaying a second series of content items on the certain zone. The second series of content items may include advertisements, textual items or images. The certain screen area may serve a mobile device having a touch screen. Alternatively, the user signals are provided by tracking a user eye. The user signals may indicate that the user scrolls the first series of content items in a certain direction for displaying further content items of the first series exposable at the certain direction while hiding instantly uninterested content items located in a countering direction. Thereby, the user signals identify a certain zone in the countering direction as being outside the user attention. The second series of content items is gradually displayed while propagating in a direction substantially perpendicular to the certain direction.

### BACKGROUND OF THE INVENTION

1. Field of the Invention

The present invention relates to sponsored advertisements(ads) appearing in mobile phone applications (e.g browsers), and more particularly, to the method of displaying these ads on the screen.

2. Description of Related Art

Recently, the portion of people who use smart phones is on a significant rise. As a result, more and more people use applications designated for smart phones, including search engines for example. Actually, most of the major search engines (Google™, Bing™ etc.) have mobile version applications. In the desktop version of these search engines, sponsored advertisements (hereafter ads) appear on the top of the search result page, and on its side. In the mobile version, only a small number (2-3) of top ads can be displayed, and it is impossible to display the side ads, because of the small screen size.

The current invention aims to increase the screen area available for sponsored ads by using a “temporary dead zone” on the screen for dynamic display of the sponsored ads. A research has revealed that when the average user goes over a search result screen on his mobile phone application, he scans the screen from top to bottom. If he does not find a desired result, he scrolls the screen downwards, to look for other results. While he scrolls downwards with his finger, using a touch screen of smart phones, he tends to pay more attention to the center part of the screen because he is already gone through the top of the screen, what forms a “temporary dead zone” on the top of the screen. Similarly, when the user scrolls the screen back upwards, the “temporary dead zone” forms at the bottom of the screen (symmetrically to the previous case). The invention introduces a method of displaying sponsored ads in these “temporary dead zones”, and therefore, to produce a greater exposure and income to advertisers.

### BRIEF SUMMARY OF THE INVENTION

It is disclosed according to preferred embodiments of the present invention, a method for displaying at least two series of content items simultaneously on a certain screen area of a computerized apparatus. A first series of content items is displayed on the certain screen area as a result of a user action. The method includes receiving user signals associated with a user attention to the displayed first series of content items, extracting from the user signals an indication that the user attention is focused outside a certain zone of the certain screen area, and displaying a second series of content items on the certain zone.

The first series of content items may include textual items. The second series of content items may include advertisements, textual items or images.

In some embodiments, the certain screen area serves a mobile device.

In some embodiments, the certain screen area is sensitive to a close presence of a part of a user body, preferably at a body part-screen distance between 0 and 5 cm.

In some embodiments, the user signals are provided by tracking a user eye.

In some embodiments, the user signals indicate that the user scrolls the first series of content items in a certain direction for displaying further content items of the first series exposable at the certain direction while hiding instantly uninterested content items located in a countering direction. Thereby, the user signals identify a certain zone in the countering direction as being outside the user attention. Preferably, the second series of content items is gradually displayed the certain zone while propagating in a direction substantially perpendicular to the certain direction. Most preferably, two content items of the second series are displayed simultaneously in the certain zone while propagating in two opposing directions.

Preferably, the second series of content items is gradually displayed in the certain zone while propagating in coupling with the scrolled content items of the first series in a direction generally perpendicular to the certain direction.

In some embodiments, the second series of content items is gradually displayed in the certain zone in accordance with the user signals.

In some embodiments, a content item of the second series is displayed in the certain zone on the reversed side of a flipping content item of the first series.

In some embodiments, the second series of content items includes call for action buttons, hyper-text for example.

In some embodiments, two content item of the second series are displayed consequently in the certain zone such that one content item covers another content item. In other words, a first advertisement, for example, is displayed in an available zone, and after a while a second advertisement covers the first advertisement.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1a illustrates a textual advertisement propagating from the right hand side leftwards into an upper screen zone which has been identified as being outside the focus of a user.

FIG. 1b and FIG. 1c show the propagating advertisement of FIG. 1a continuing its leftwards propagation.

FIG. 1d shows the propagating advertisement of FIGS. 1a-c in destination.

FIG. 2a shows the textual advertisement of FIGS. 1a-d disappearing gradually upwards while a second textual advertisement is propagating from the right hand side leftwards into the upper screen zone.

FIG. 2b shows the second textual advertisement occupying the upper screen zone.

FIG. 3 illustrates an annotated advertisement propagating from the right hand side leftwards into an upper screen zone which has been identified as being outside the focus of a user.

FIG. 4a illustrates a first image advertisement propagating from the right hand side leftwards into an upper screen zone which has been identified as being outside the focus of a user.

FIG. 4b shows the first image advertisement coupled to the upward moving text while a second image advertisement propagates from the right hand side leftwards.

FIG. 5 is a flow chart of a method for displaying two series of content items.

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described device is necessary to implement the invention as claimed in any particular one of the appended claims. Various elements and features of devices are described to fully enable the invention.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

The current invention aims to increase the screen area available for sponsored ads by using a “temporary dead zone” or an available zone on the screen for dynamic display of the sponsored ads. When an average user goes over a search result screen he scans a screen from top to bottom. If he does not find a desired result, he scrolls the screen downwards, to look for other results. While he scrolls downwards with his finger, using a touch screen of smart phones, he tends to pay more attention to the center part of the screen because he is already gone through the top of the screen, what forms an available zone on the top of the screen.

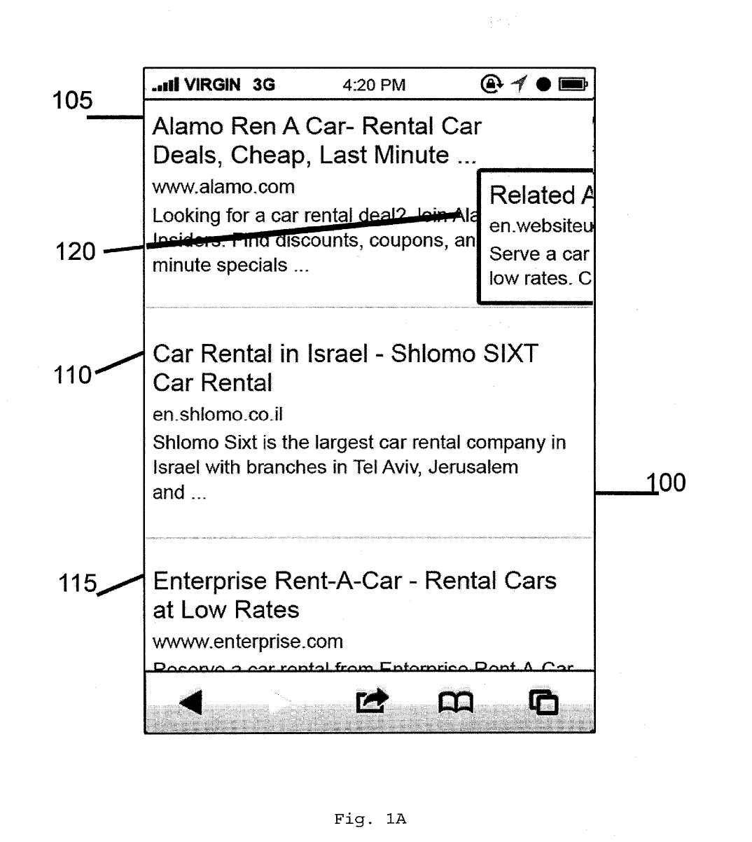

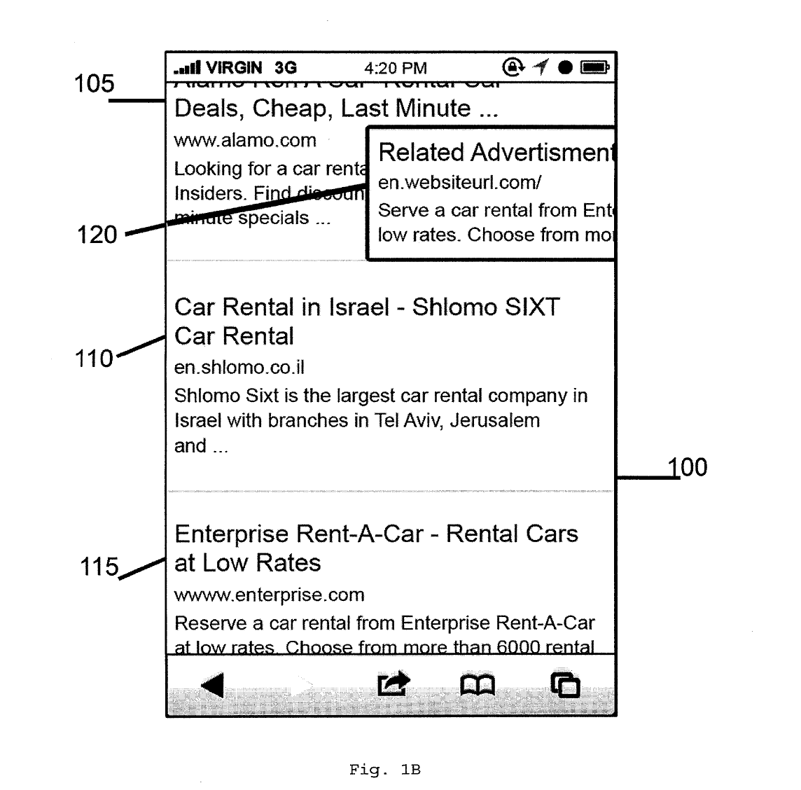

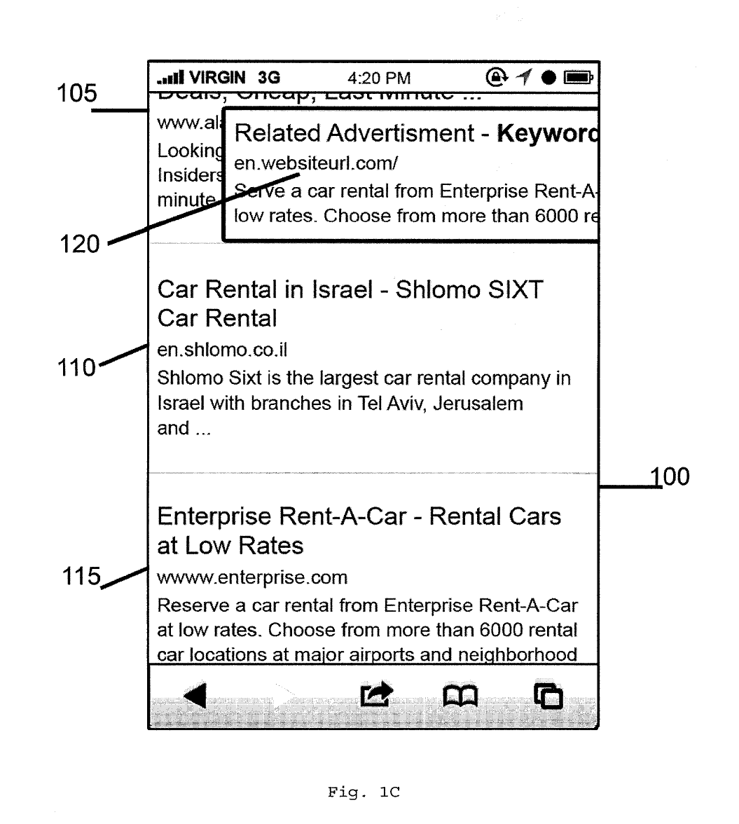

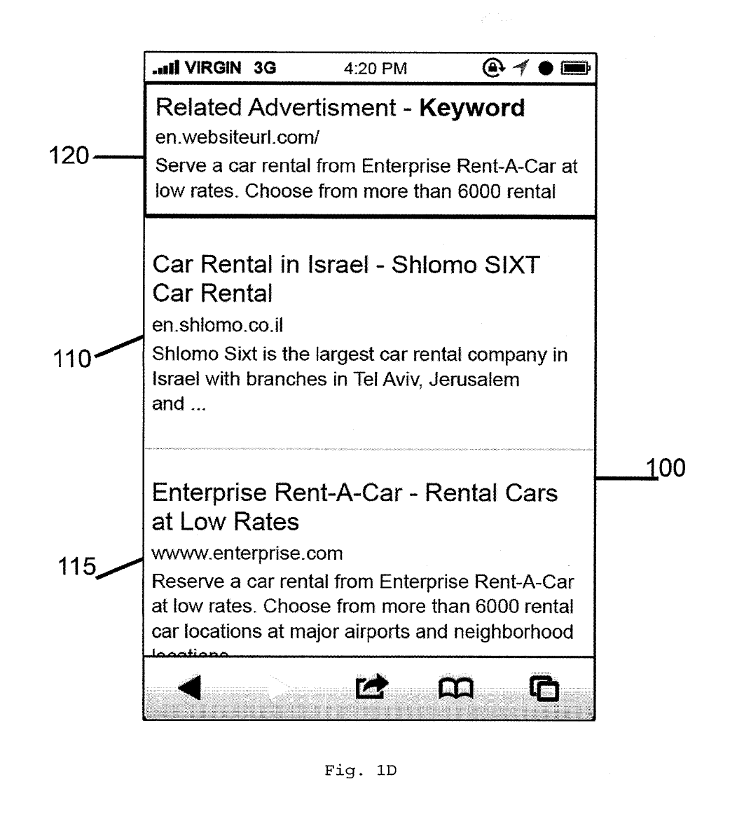

A typical touch screen 100 of a smart phone is shown in the example of FIG. 1a. In a response to a user search inquiry for car rentals in Israel, text items 105, 110 and 115 are displayed. However, the provider of the search results (GOOGLE™ for example) is interested to attract the user attention to certain advertisements for service that may be attractive to the user who initiated the search. The provider is motivated by payment by the ads' publishers in accordance with the ad exposures(pay per mile) and/or user clicks(pay per click).

A software module responsible for managing the integration of an ad stream with the requested content items is called an ad unit. A typical prior art ad unit precedes the requested search results 105, 110 and 115 by several advertisements, thus enforcing the user to pay some attention to the ads. Usually, the user skips almost immediately to the requested search results, ignoring the ads as they were not asked for.

An ad unit of the present invention integrates ads with a desired text stream in a way, which is simultaneously more pleasant to the user and more effective for the provider. In the example of FIG. 1a, the user read items 105 and 110 and scrolls downwards to get the full text of item 115. The ad unit receives the scrolling signals and interprets them correctly as designating that currently the upper zone of the screen is outside the user focus and is available for presenting an ad without disturbing the user. Consequently, the ad unit lets a first ad 120 to accommodate the upper part of the screen.

In the example of FIGS. 1a, 1b, 1c and 1d ad 120 propagates gradually from the right hand side leftwards until it covers item 105 completely. Note that this process is reversible under the user control. In case that the user reverses direction and begins to scroll the search result upwards, ad 120 disappears gradually in accordance with the movement of the user's finger. In such a case, an ad (not shown) may accommodate the lower zone of the screen as the ad unit interprets the scrolling upwards as an indication that the user is not focusing on the lower zone.

Rather than propagating from the right hand side leftwards, an ad may propagate in the reverse direction, from the left hand side rightwards. Alternatively, ad 120 may accommodate an available zone at once, or in any other way known in the art for attracting user attention. Also, two ads may be displayed simultaneously in the available zone while propagating in two opposing directions.

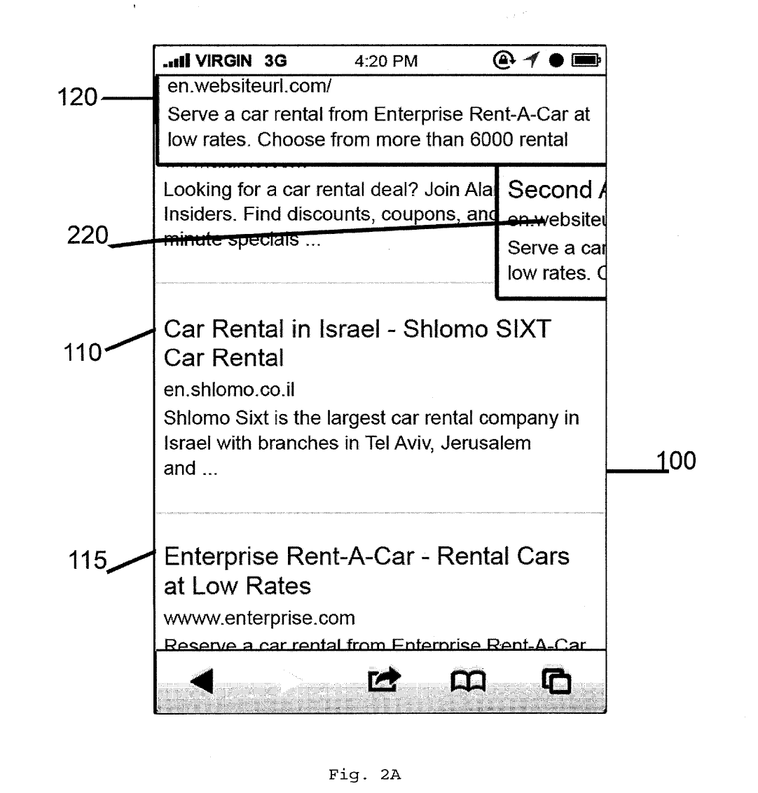

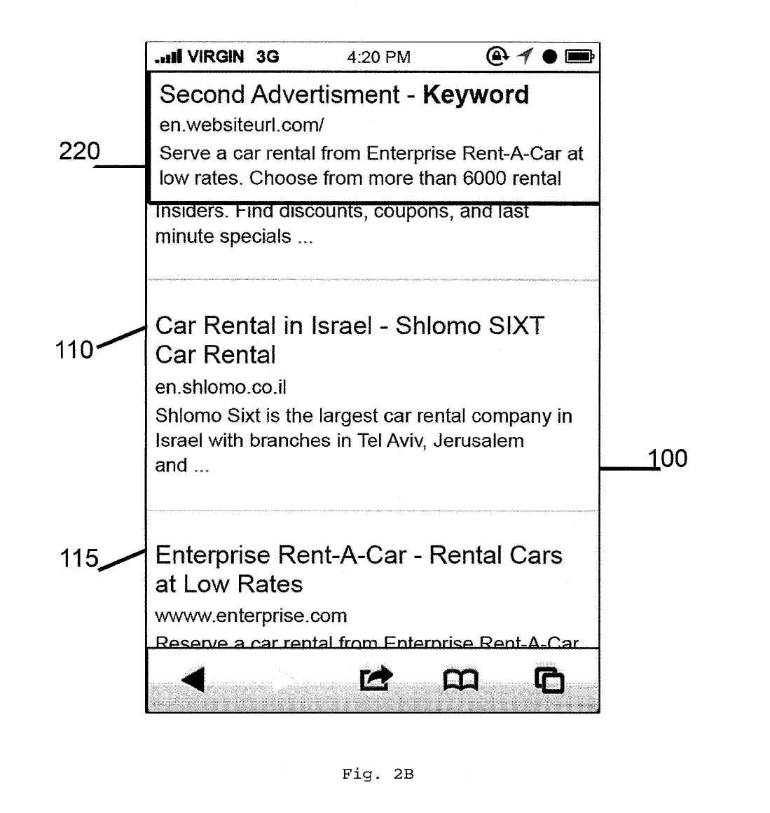

A stream of ads propagates into the available zone of screen 100, as presented by FIGS. 2a and 2b. Once ad 120 is fully exposed, as shown in FIG. 1d, a second ad 220 starts to propagates from the right hand side leftwards under ad 120, such that finally ad 120 disappears and ad 220 is fully exposed for a while. This process continues on and on without disturbing the user attention to the data stream she has requested, while giving an opportunity to the ads to gently attract her attention.

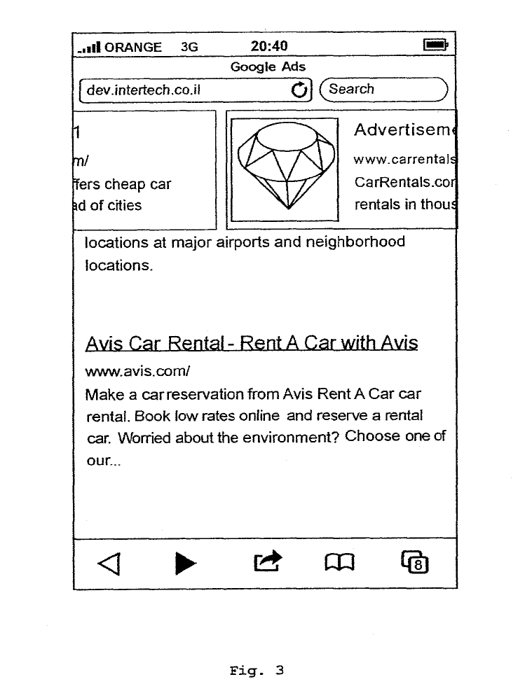

Rather than text ads, the ad unit may launch annotated ads or ads having an embedded image like ad 320 of FIG. 3.

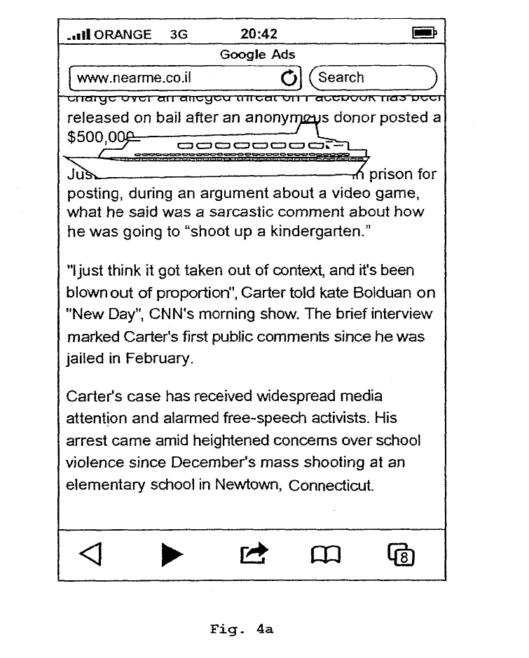

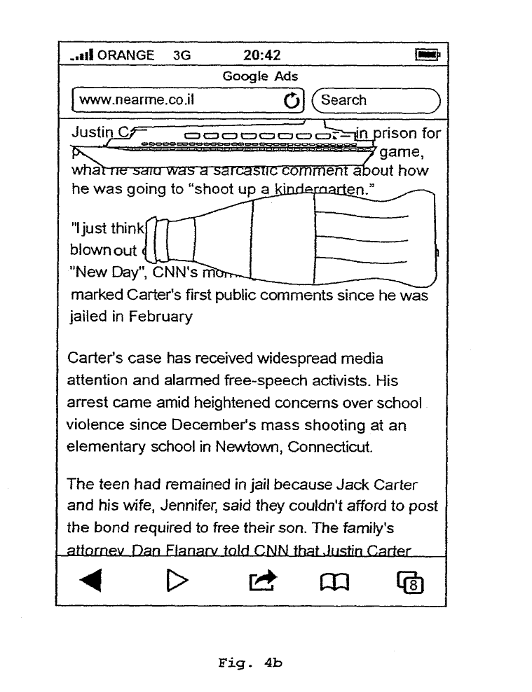

Referring now to FIGS. 4a and 4b, the desired content items which have been displayed in response to a user request include the paragraphs of a news item. The ad streams includes images which resemble an advertised product, like a cruise ship 420 and a Coca-Kola™ bottle 425, propagating into the available zoon in the upper part of screen 100 one after another in a direction perpendicular to the scrolling up-down direction. Note that the location of cruise ship 420 is coupled to the underneath text and not to the frame of the screen. Thus, as the text is scrolled upwards and the upper paragraphs goes up and disappear, so does cruise ship 425.

Generalizing a touch screen, the screen area may be sensitive to a close presence of a part of a user body not only to a touch, preferably at a finger-screen distance between 0 and 5 cm. Thus, a user finger may hover over the screen to scroll it downwards or upwards, and the apparatus having the screen detects the hovering as a signal of scrolling, the ad unit receives either the hovering signals or the scrolling interpretation and extracts from them that a certain zone is free of the user attention and is available for ads. Alternatively, the device having the screen has means for tracking a user eye, and provides user signals regarding the zone getting user attention, from which the ad unit extracts the identification of an available zone for ads.

Note that the screen area used for displaying the two series of content items may be a portion of a larger screen, of a laptop computer or of a desktop computer for example.

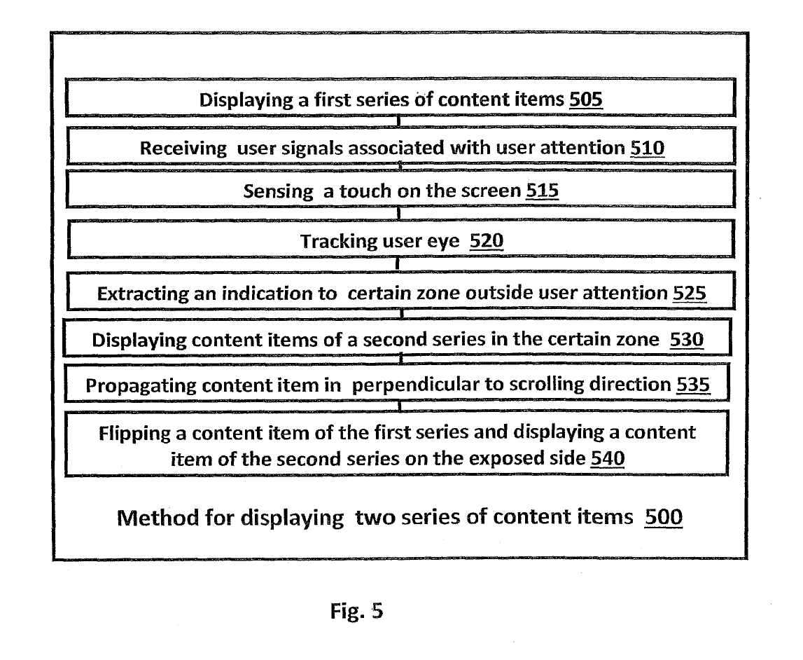

Before referring to a method 500 of FIG. 5, it is noted that the steps of method 500 may be performed in any order or simultaneously, unless it is clear from the context that one step depends on another being performed first.

The flow chart of FIG. 5 presents method 500 for displaying two series of content items simultaneously on a certain screen area 100 of a computerized apparatus. A first series of content items is displayed in step 505 on the certain screen area as a result of a user action. Method 500 includes a step 510 of receiving user signals relating to a user attention to the displayed first series of content items, a step 525 of extracting from the user signals an indication that the user attention is focused outside a certain zone, and a step 530 of displaying a second series of content items on the certain zone.

The user signals may be produced by the computerized device in a step 515 by sensing a touch of a user finger on the screen, or by a step 520 of tracking a user eye looking at screen 100. The user signals indicate that the user scrolls the first series of content items in a certain direction for displaying further content items of the first series exposable at the certain direction while hiding instantly uninterested content items located in a countering direction. Thereby, the user signals identify a certain zone in the countering direction as being outside the user attention.

Preferably, the second series of content items is gradually displayed in the certain zone while propagating in step 535 in coupling with the scrolled content items of the first series in a direction generally perpendicular to the certain direction.

In step 540, a content item of the second series is displayed in the certain zone on the reversed side of a flipping content item of the first series.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. A method for displaying at least two series of content items simultaneously on a certain screen area of a computerized apparatus, a first series of content items being displayed on the certain screen area as a result of a user action, the method comprising:
(a) receiving a plurality of user signals associated with a user attention to the displayed first series of content items;
(b) extracting from at least part of said plurality of user signals an indication that said user attention being focused outside a certain zone of the certain screen area; and
(c) displaying a second series of content items on at least part of said certain zone.

2. The method of claim 1 wherein said first series of content items includes textual items.

3. The method of claim 2 wherein said first series of content items consists of textual items.

4. The method of claim 1 wherein said second series of content items includes advertisements.

5. The method of claim 4 wherein said advertisements include textual items.

6. The method of claim 4 wherein said advertisements include images.

7. The method of claim 1 wherein said certain screen area serves a mobile device.

8. The method of claim 1 wherein said certain screen area is sensitive to a close presence of a part of a user body.

9. The method of claim 8 wherein said certain screen area is sensitive to a presence of a part of a user body located at a body part-screen distance between 0 and 5 cm.

10. The method of claim 1 wherein said plurality of user signals includes signals provided by tracking at least one user eye.

11. The method of claim 1 wherein said at least part of said plurality of user signals indicates that said user scrolls said first series of content items in a certain direction for displaying further content items of said first series exposable at said certain direction while hiding instantly uninterested content items located in a countering direction, thereby identifying a certain zone in said countering direction as being outside said user attention.

12. The method of claim 11 wherein said second series of content items is gradually displayed in said at least part of said certain zone while propagating in a direction substantially perpendicular to said certain direction.

13. The method of claim 12 wherein two content items of said second series are displayed simultaneously in said at least part of said certain zone while propagating in two opposing directions.

14. The method of claim 11 wherein said second series of content items is gradually displayed in said at least part of said certain zone while propagating in at least partial coupling with the scrolled content items of the first series in a direction generally perpendicular to said certain direction.

15. The method of claim 1 wherein said second series of content items is gradually displayed in said at least part of said certain zone in accordance with said plurality of user signals.

16. The method of claim 1 wherein a content item of said second series is displayed in said at least part of said certain zone on the reversed side of a flipping content item of the first series.

17. The method of claim 1 wherein said second series of content items includes call for action buttons.

18. The method of claim 1 wherein at least two content items of said second series are displayed consequently in said certain zone such that one content item thereof covers another content item thereof.
